(19) United States
(12) Patent Application Publication
(10) Pub. No.: US 2016/0054226 A1
(43) Pub. Date: Feb. 25, 2016

(54) An image forming method of a fluorescent sample

(71) Applicants: Daniela Gandolfi, Borgarello (PV) (IT); Jonathan Mapelli, Modena (MO) (IT); Egidio D.Angelo, Torre d'Isola (PV) (IT); Paolo Pozzi, Villa d'Alme' (BG) (IT)

(72) Inventors: Daniela Gandolfi, Borgarello (PV) (IT); Jonathan Mapelli, Modena (MO) (IT); Egidio D.Angelo, Torre d'Isola (PV) (IT); Paolo Pozzi, Villa d'Alme' (BG) (IT)

(21) Appl. No.: 14/778,351

(22) PCT Filed: Mar. 22, 2014
(86) PCT No.: PCT/IB2014/060057

§ 371 Date: Sep. 18, 2015

(30) Foreign Application Priority Data
Mar. 25, 2013 (IT) MO213A00078

(51) Int. Cl. G01N 21/64

(52) U.S. Cl. CPC G01N 21/6458; G01N 2201/105; G01N 2201/06113

(57) ABSTRACT

A method of imaging a fluorescent sample includes the steps of: scanning fluorescent points of the sample using a scanner apparatus, thereby obtaining scanned fluorescent points; and imaging the scanned fluorescent points on a display, the scanning including the steps of predefining a scan field for the sample, which includes a set of scannable fluorescent points; and sequentially irradiating, at least one first subset of points of the set of points and at least one second subset of the set of points, which complements the first subset with respect to the set of points. The first and second subsets can be irradiated at different focal irradiation distances.

### FIELD OF THE INVENTION

The invention relates to a method of imaging a fluorescent sample using the technique known as two-photon fluorescence microscopy, which can be generally used to generate an image of the detected surface.

### BACKGROUND ART

Fluorescence scanning is often performed using scan heads mounted to microscopes that can detect samples loaded with a fluorophore that allows detection of their edge and surface points, in other words, of their perimeter conformation in a detection plane.

More in detail, this type of scans requires the use of a pulsating infrared laser beam which is focused into a very small volume of the sample to be scanned, of the order of a cubic micron.

If the fluorescent dye is present in this very small volume, it will emit a fluorescent light which is sensed by a camera or the like and transmitted to an apparatus that displays the fluorescence signal, e.g. on a display screen.

Typically, since the surfaces to be imaged have usually much larger surface areas than that on which the laser beam is focused, the whole surface of a sample can be only imaged by providing additional devices that form the scan head of the microscope and allow the laser beam to be moved in predetermined directions, typically along parallel overlapping rows, until the whole surface to be imaged is scanned, thereby obtaining the final image by capturing the individual fluorescence emissions of the fluorophore.

A larger scan of a sample surface may be also obtained using a device known as D.O.E. (Diffractive Optical Element), which provides appropriate phase modulation of the laser beam to divide it into a beam of parallel sub-beams which simultaneously illuminate multiple fluorescent points of a sample, thereby allowing a fixed distribution of points that may be used by an experimenter.

When the illuminated points are fluorescent, fluorescence signals are generated, which are sent to a display device.

Nevertheless, prior art devices suffer from certain drawbacks.

A first drawback is that microscope scan heads that can displace the laser beam for scanning all the points of the sample have a very high cost, due to their complex structure.

A second drawback concerning the use of the D.O.E. device is that, since the latter can only provide a fixed distribution of sub-beams, it must be associated with a beam displacing apparatus to obtain a final image having a sufficient resolution.

It should be noted that, theoretically, scans having a higher definition in terms of scanning points might be obtained by considerably increasing the number of points to be impinged upon by the laser beam, by changing its phase.

Nevertheless, this multiplication of points would cause a proportional increase of the power required to illuminate the sample, which is not currently available in any known laser source.

### Disclosure of the Invention

One object of the invention is to improve the prior art.

Another object of the invention is to provide a method of imaging a fluorescent sample that can provide images of the sample using a microscope that has no additional apparatus for displacing the scan beam over the sample surface that is required to be imaged for fluorescent point detection.

In one aspect, the invention provides a method of imaging a fluorescent sample as defined by the features of claim 1.

In another aspect, the invention provides an apparatus for imaging a fluorescent sample as defined by the features of claim 4.

The invention achieves the following advantages:

considerably simplifying the structure of scan heads mounted to microscopes for two-photon fluorescence microscopy imaging of a sample element;

obtaining images with substantially the definition that can be obtained with prior art apparatus having a more complex and expensive structure.

### BRIEF DESCRIPTION OF THE DRAWINGS

Further features and advantages of the invention will be more readily apparent upon reading of the detailed description of a preferred non-exclusive embodiment of a method of imaging a fluorescent sample, which is shown as a non-limiting example by the annexed drawings, in which:

FIG. 1 is a first schematic example of a schematic view of a scan field, showing a first subset of points irradiated by a first distribution of scan beams;

FIG. 2 is a second schematic example of a schematic view of a scan field, showing a second subset of points, complementing the first subset, which are irradiated by a second distribution of scan beams;

FIG. 3 is a schematic example of a general view of a set of scannable fluorescent points;

FIG. 4 is a third schematic example of a schematic view of a scan field, showing a third subset of points irradiated by a third distribution of scan beams;

FIG. 5 is a fourth schematic example of a schematic view of a scan field, showing a fourth subset of points irradiated by a fourth distribution of scan beams;

FIG. 6 is a fifth schematic example of a schematic view of a scan field, showing a fifth subset of points irradiated by a fifth distribution of scan beams;

FIG. 7 is a schematic example of a general view of an additional set of scannable fluorescent points;

FIG. 8 is a general schematic view of a scanner apparatus for implementing the method of the invention;

FIG. 9 is a flow-chart of the steps of the method of the invention.

### DETAILED DESCRIPTION OF A PREFERRED EMBODIMENT

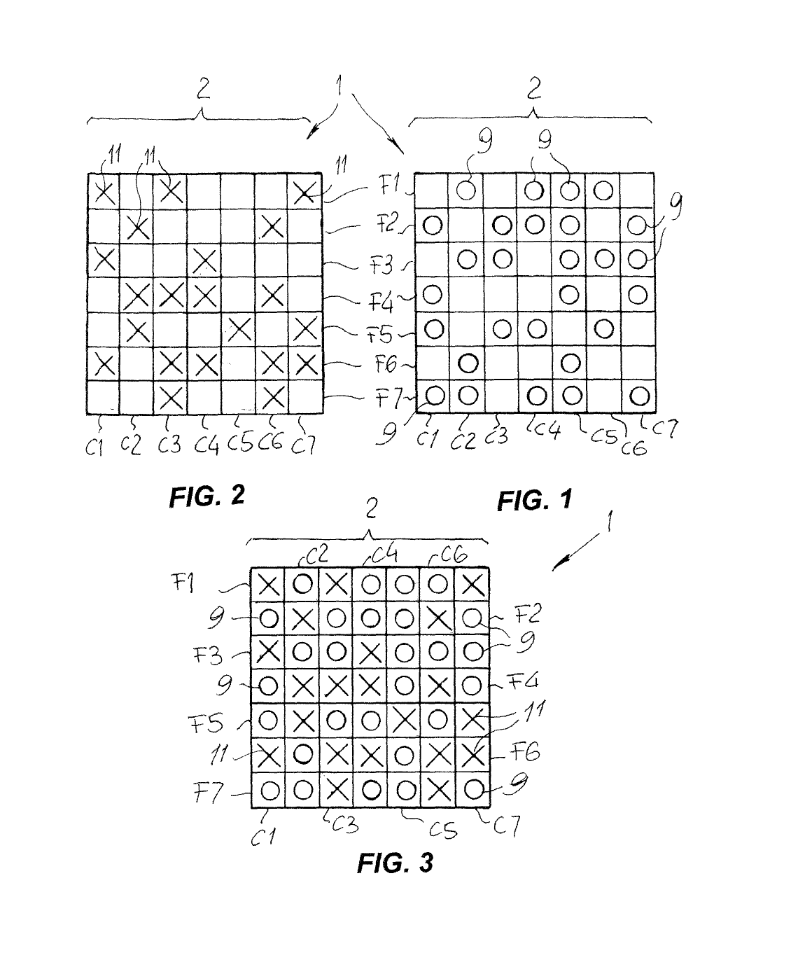

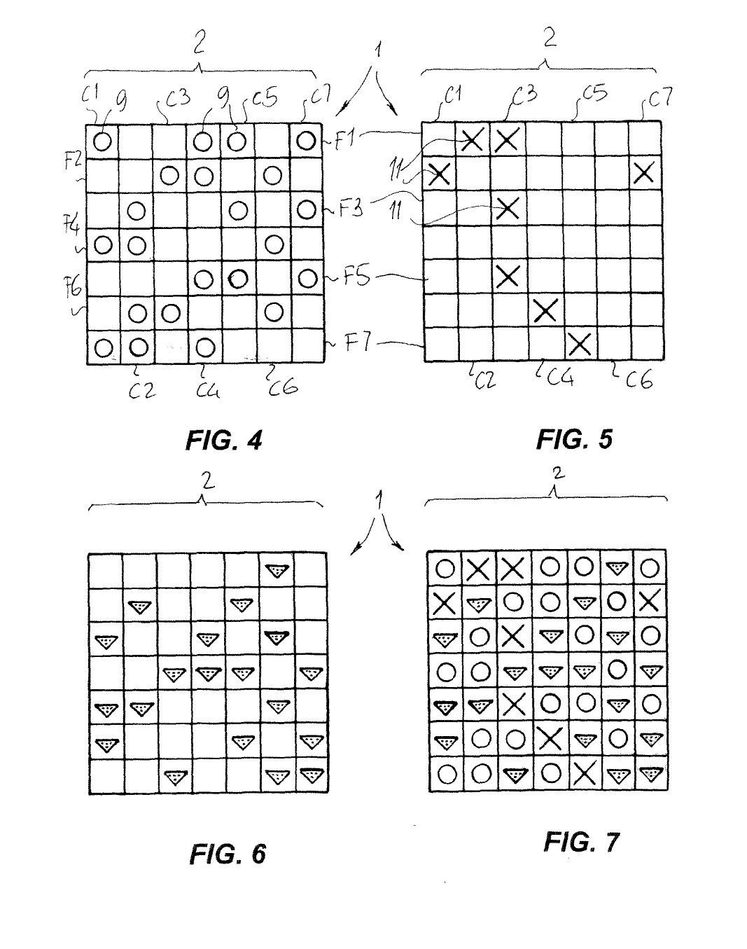

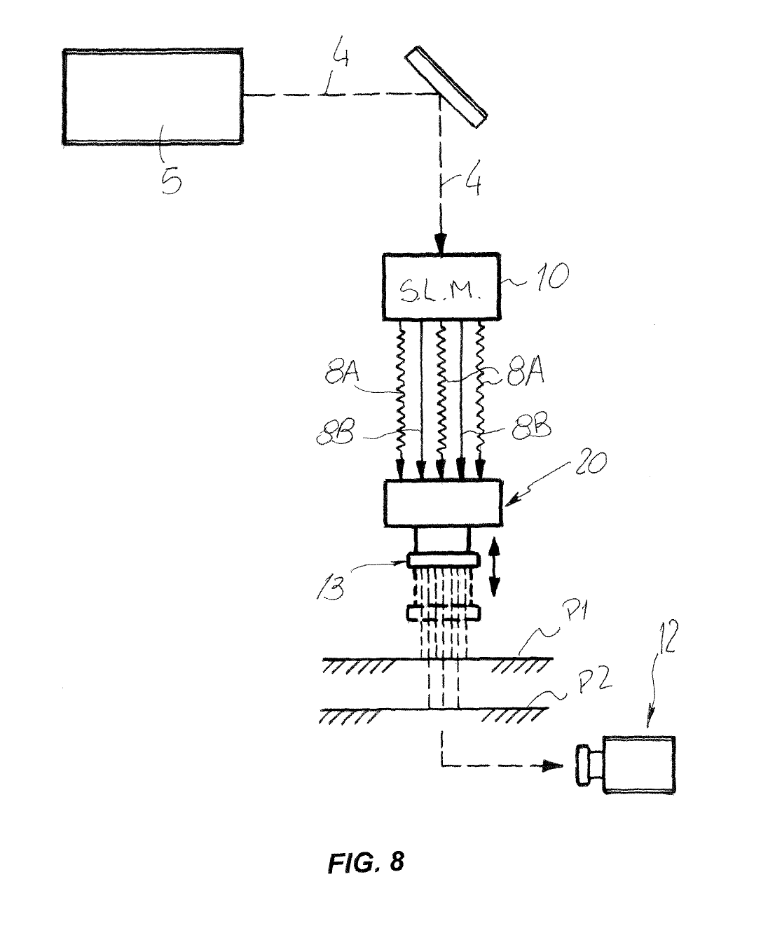

Referring now to FIGS. 1 to 3, numeral 1 designates a sample element which, for example, is represented by a grid having rows “F1-F7” and columns “C1-C7” of cells that generally form a scan field 2, hereinafter briefly referred to as field 2, here a flat square geometric figure.

The skilled person will understand that the illustrated grid may have any perimeter and composition and that, as mentioned above, it is merely a schematic, non-limiting example of a sample to be analyzed.

As shown in FIG. 3, the scan field 2 contains a set of detectable points that have the common feature of being fluorescent and hence detectable when a scan beam, such as a laser beam 4, indicated with a broken line in FIG. 8 and emitted by a source 5, impinges thereupon.

Before irradiating the field 2, the laser beam 4 is modulated by a known S.L.M. (Spatial Light Modulator) device, referenced 10, which divides it into a first predetermined number of sub-beams 8A that form a first beam of scan laser sub-beams.

When the first distribution of beams 8 irradiates the sample 1 in a first initial detection step, it generates a first subset of first detected points, conventionally indicated as small circle 9 in FIGS. 1 to 3, also referred to hereinafter as first points 9, on a first perpendicular scan plane, typically the plane “P1” on which the field 2 lies.

This first subset of first scanned points provides a first part of the image (in pixels), which is transmitted to a display apparatus, schematically referenced 12 in FIG. 8, which reproduces a first part of the overall image to be captured.

By making changes in the program for spatially composing and organizing the laser beam emitted by the S.L.M. device 10 of the invention, a second beam of detection laser sub-beams 8B is obtained, which is spatially different from the first beam 8A such that, when it irradiates the sample 1 in a later detection step, it will generate a second subset of second detected fluorescent points, conventionally indicated in the figures with cross symbols 11, and hereinafter also referred to as second points 11.

As noted with reference to FIG. 3, in this exemplary case the number of second points 11 of the second subset complements the number of first points 9, to reach the total number of points that form the set of the detectable points of the field 2.

The second image part of this second subset is also sent to the display apparatus 12 which integrates it with the first previously captured part to form the whole image of the field 2 of the sample 1.

It shall be noted that, according to the invention, three-dimensional images may be also captured and reproduced, by adjusting the focus of a lens 13 of a focusing apparatus 20 situated downstream from the S.L.M. device, through which the beams 8A and 8B pass.

In this case, the second subset of scanned points 11 is detected on a second plane “P2” other from the plane “P1” and normally parallel thereto.

Repeated scans on multiple planes with changed focus allows capture of images that are transmitted to the display apparatus 12 to reconstruct a three-dimensional image thereon.

It shall be noted that the term “making changes in the program of the S.L.M. device” is intended to mean that a phase distribution of the laser beam 8B is selected to perform a second detection, such that an illumination distribution selected by the experimenter and different from that of the beam 8A as used for the first detection is obtained on the plane of sample to be analyzed.

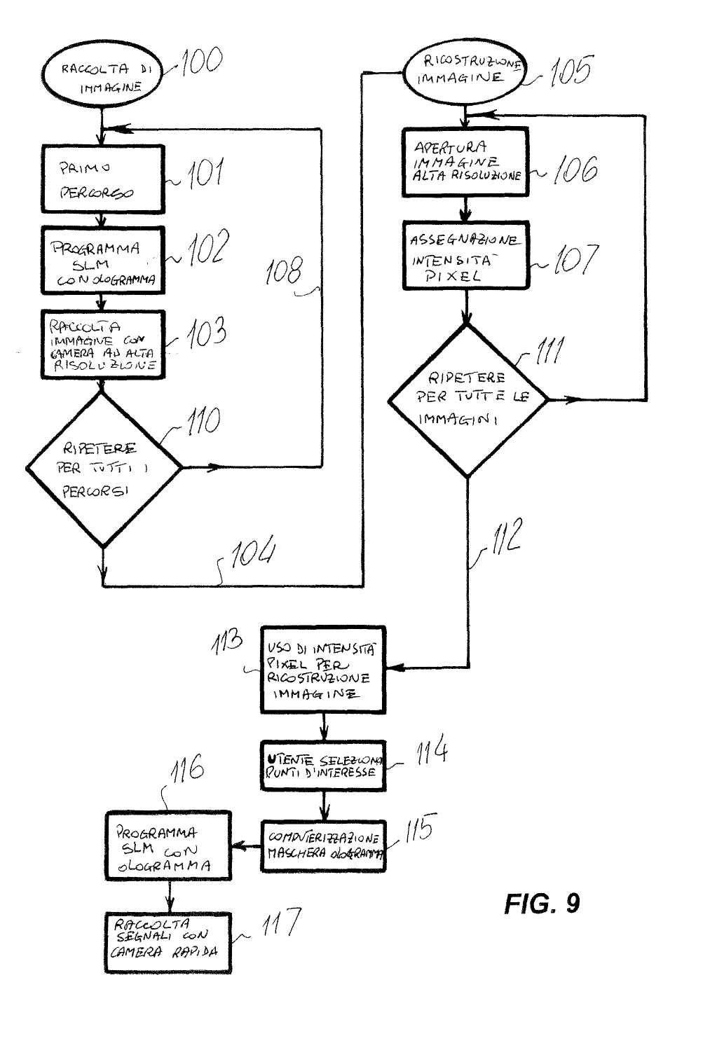

Referring to FIG. 9, a flowchart is shown, which illustrates the sequence of steps of the method of imaging a sample according to the invention.

Particularly, the step 100 indicates the start of the method of capturing/acquiring an image, followed by a step 101 of selecting the detection of a first subset of first detectable points 9 of a scan field 2.

The step 101 is followed by a further step 102, which is the starting step during which the first beam 8A of laser sub-beams is generated, using a hologram-template, by the S.L.M. device 10 which irradiates the sample in the first subset of the first selected points 9.

In the next step 103, the first subset of detected points 9 is sent to the display means 12 along the flow line 104 that comes out of the selection step 110 and reaches the step 105, in which reconstruction of an image to be constructed and displayed starts.

In the next step 106, a first part of an image to be constructed in the display means 12 is opened, and a pixel intensity is assigned to this first part, in the following step 107.

As shown by the flow line 108 that comes out of the selection step 110, as an alternative to the flow line 104, this first part of the detection method of the invention is repeated in a subsequent step for detection of at least one second subset of detectable points 11, which defines a second part of the image to be constructed and which, like the previous one, is later sent to the step 105 and to those that follow, 106 and 107.

After this step 107, once pixel intensities have been assigned to at least both the detected image parts, a selection step 11 is provided, in which the method is repeated from the step 106 for any further subset of detected points.

Once all the subsets of detectable points have been detected, after the flow line 112 the method of the invention includes the image reconstruction step 113, which is followed by the step 114 of selecting the particular points of interest of the image reconstructed by joining the subsets of detected points 9 and 11, the step 115 of generating a hologram template of the points of interest, the step 116 of programming the S.L.M. device 10 with the hologram template and the step 117 of capturing the image by a camera.

The invention has been found to fulfill the intended objects.

The invention so conceived is susceptible to changes and variants within the inventive concept.

Also, all the details may be replaced by other technical equivalent elements.

In its practical implementation, any material, shape and size may be used as needed, without departure from the scope as defined by the following claims.

The invention claimed is:

1. An image forming method of a fluorescent sample comprising the steps of:
detecting fluorescent points (9, 11) of said sample by a detecting apparatus (10, 8A, 8B), obtaining therefrom detected fluorescent points; and
forming images of said detected fluorescent points on a display (12);
wherein the step of detecting comprises:
pre-defining a scanning field (2) of said sample, which comprises a set of fluorescent detectable points (9, 11);
irradiating statically in a first initial step at least a first sub-set of first points (9) of said set of detectable points by a first irradiating beam (8A) generated by an irradiation device (10);
resetting said irradiation device (10) to generate a second irradiating beam (8B) different from said first irradiating beam (8A);
irradiating statically in a subsequent irradiation step at least a second sub-set of second points (11) of said set of detectable points by said second irradiating beam (8B) generated by said reset irradiation device (10), which are different from said first points (9) and that form said set of detectable points when added to said first sub-set; and
completing an image on said display (12) by supplementing reciprocally said first sub-set and second sub-set of detected points.

2. The image forming method as claimed in claim 1, wherein said first irradiating beam comprises a first beam (8A) of detecting laser rays which define a first detecting net comprising said first sub-set of points and said second irradiating beam comprises at least a second beam (8B) of detecting laser rays which define a second detecting net comprising said second sub-set of points, said first beam (8A) of detecting laser rays and said second beam (8B) of detecting laser rays being generated by said irradiating device (10).

3. The image forming method as claimed in claim 1, wherein said irradiating device comprises a spatial light modulator (10).

4. The image forming method as claimed in claim 1, wherein said step of irradiating comprises irradiating said first sub-set at a first focal irradiation distance (P1) with respect to said sample and to irradiate said second sub-set at a second focal irradiation distance (P2) with respect of said sample, different from said first distance (P1).

5. The image forming method as claimed in claim 1, wherein said first sub-set and second sub-set are reciprocally supplemental with respect of said set of detectable points.

6. An image generating apparatus of a fluorescent sample, comprising:
a source (5) of a detecting ray beam (4); and
a spatial light modulator 810) equipped with a phase modulator, designed to modify a phase of said detecting ray beam (4) into at least a first beam (8A) of detecting sub-rays of a first sub-set of detectable points (9) and into a second beam (8B) of detecting sub-rays of a second sub-set of detectable points (11) of said sample.
